(19) United States
(12) Patent Application Publication
(10) Pub. No.: US 2022/0252838 A1
(43) Pub. Date: Aug. 11, 2022

(54) LENS UNIT, OPTICAL SYSTEM, AND ELECTRONIC APPARATUS

(71) Applicants: Yoshifumi SUDOH, Kanagawa (JP); Yasuo KATANO, Kanagawa (JP); Shigenobu HIRANO, Kanagawa (JP); Masahiro ITOH, Kanagawa (JP); Naoki NAKAMURA, Saitama (JP); Susumu MOMMA, Kanagawa (JP); Shun OKAZAKI, Kanagawa (JP); Masamichi YAMADA, Kanagawa (JP); Kenji KAMEYAMA, Kanagawa (JP); Norikazu IGARASHI, Kanagawa (JP); Aino HASEGAWA, Kanagawa (JP); Takashi MAKI, Kanagawa (JP)

(72) Inventors: Yoshifumi SUDOH, Kanagawa (JP); Yasuo KATANO, Kanagawa (JP); Shigenobu HIRANO, Kanagawa (JP); Masahiro ITOH, Kanagawa (JP); Naoki NAKAMURA, Saitama (JP); Susumu MOMMA, Kanagawa (JP); Shun OKAZAKI, Kanagawa (JP); Masamichi YAMADA, Kanagawa (JP); Kenji KAMEYAMA, Kanagawa (JP); Norikazu IGARASHI, Kanagawa (JP); Aino HASEGAWA, Kanagawa (JP); Takashi MAKI, Kanagawa (JP)

(21) Appl. No.: 17/588,354

(22) Filed: Jan. 31, 2022

(30) Foreign Application Priority Data
Feb. 5, 2021 (JP) 2021-017064

(51) Int. Cl. G02B 13/00; H04N 5/225; G02B 7/02; G02B 3/00

(52) U.S. Cl. CPC G02B 13/006; H04N 5/2254; G02B 2003/0093; G02B 3/00; G02B 7/021

(57) ABSTRACT

A lens unit includes: a lens group including: an object-side lens closest to an object side in the lens group; an image-side lens closest to an image side in the lens group; and an intermediate lens between the object-side lens and the image-side lens, the object-side lens, the image-side lens, and the intermediate lens being arranged along an optical axis; a first holder holding an edge surface of the object-side lens and an edge surface of the intermediate lens; and a second holder separate from the first holder, the second holder holding the edge surface of the intermediate lens and an edge surface of the image-side lens.

### CROSS-REFERENCE TO RELATED APPLICATIONS

This patent application is based on and claims priority pursuant to 35 U.S.C. § 119(a) to Japanese Patent Application No. 2021-017064, filed on Feb. 5, 2021, in the Japan Patent Office, the entire disclosure of which is hereby incorporated by reference herein.

### BACKGROUND

### Technical Field

The present disclosure relates to a lens unit, an optical system, and an electronic apparatus.

### Related Art

A lens unit in which multiple lenses are arranged in a lens barrel is known. A position of each lens in the lens barrel is defined by a surface of an inner wall of the lens barrel and a spacer disposed in the lens barrel.

### SUMMARY

A lens unit includes: a lens group including: an object-side lens closest to an object side in the lens group; an image-side lens closest to an image side in the lens group; and an intermediate lens between the object-side lens and the image-side lens, the object-side lens, the image-side lens, and the intermediate lens being arranged along an optical axis; a first holder holding an edge surface of the object-side lens and an edge surface of the intermediate lens; and a second holder separate from the first holder, the second holder holding the edge surface of the intermediate lens and an edge surface of the image-side lens.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a block diagram of an electronic apparatus according to a first embodiment;

FIG. 2 is a perspective view of a lens unit according to a first embodiment incorporated in the electronic apparatus in FIG. 1;

FIG. 3 is an exploded perspective view of the lens unit in FIG. 2 according to the first embodiment;

FIG. 4 is a cross-sectional view of a lens unit in FIG. 2 according to the first embodiment;

FIG. 5 is a perspective view of a lens unit according to a second embodiment incorporated in the electronic apparatus in FIG. 1;

FIG. 6 is an exploded perspective view of the lens unit in FIG. 5 according to the second embodiment;

FIG. 7 is a cross-sectional view of the lens unit in FIG. 5 according to the second embodiment;

FIG. 8 is a perspective view of a lens unit according to a third embodiment incorporated in the electronic apparatus in FIG. 1;

FIG. 9 is an exploded perspective view of the lens unit in FIG. 8 according to the third embodiment;

FIG. 10A is a cross-sectional view of the lens unit in FIG. 8 according to the third embodiment;

FIG. 10B is a cross-sectional view of the lens unit in FIG. 8 according to the third embodiment;

FIG. 11 is a perspective view of a lens unit according to a fourth embodiment incorporated in the electronic apparatus in FIG. 1;

FIG. 12 is an exploded perspective view of the lens unit in FIG. 11 according to the fourth embodiment;

FIG. 13 is a cross-sectional view of the lens unit in FIG. 11 according to the fourth embodiment;

FIG. 14 is a perspective view of a lens unit according to a fifth embodiment incorporated in the electronic apparatus in FIG. 1;

FIG. 15 is an exploded perspective view of the lens unit in FIG. 14 according to the fifth embodiment;

FIG. 16A is a cross-sectional view of the lens unit in FIG. 14 according to the fifth embodiment;

FIG. 16B is a cross-sectional view of the lens unit in FIG. 14 according to the fifth embodiment and;

FIG. 17 is a cross-sectional view of an optical system according to the sixth embodiment.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to the present disclosure, the ease of assembly of a lens unit, an optical system, and an electronic apparatus is improved.

A lens unit, an optical system including the lens unit, and an electronic apparatus including the optical system according to an embodiment is described with reference to the drawings.

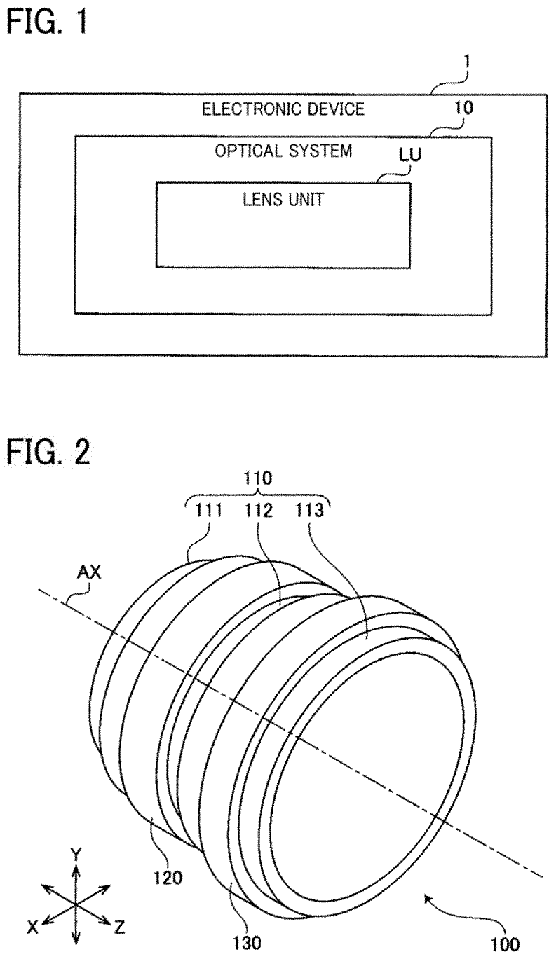

FIG. 1 is a block diagram of an electronic apparatus 1 according to an embodiment. As illustrated in FIG. 1, an electronic apparatus 1 includes an optical system 10 for image capturing and projection and is, for example, a digital camera, a virtual image display device, a projector, a smartphone, a tablet PC, a video camera, or a portable game machine.

The optical system 10 includes at least one lens unit LU disposed on the optical axis. The number of lens units LU included in the optical system 10 varies depending on a model or a specification of the electronic apparatus 1.

A configuration of the lens unit LU included in the optical system 10 is described. As illustrated in the drawings below, the lens unit LU includes a lens group and multiple holders. In the first embodiment, a lens unit 100, which is an example of the lens unit LU, holds three circular lenses included in a lens group by using two holders. In a second embodiment and a third embodiment, lens units 200 and 300, which are examples of the lens unit LU, hold three non-circular lenses included in a lens group using two holders. In a fourth embodiment and a fifth embodiment, lens units 400 and 500, which are examples of the lens unit LU, hold four non-circular lenses included in a lens group using three holders.

The configurations of the lens unit (e.g., the number and shape of lenses and the number and shape of holders) described in each embodiment are merely one example. The configurations of the lens unit are not limited thereto, there are latitude in configuration of the lens unit.

### First Embodiment

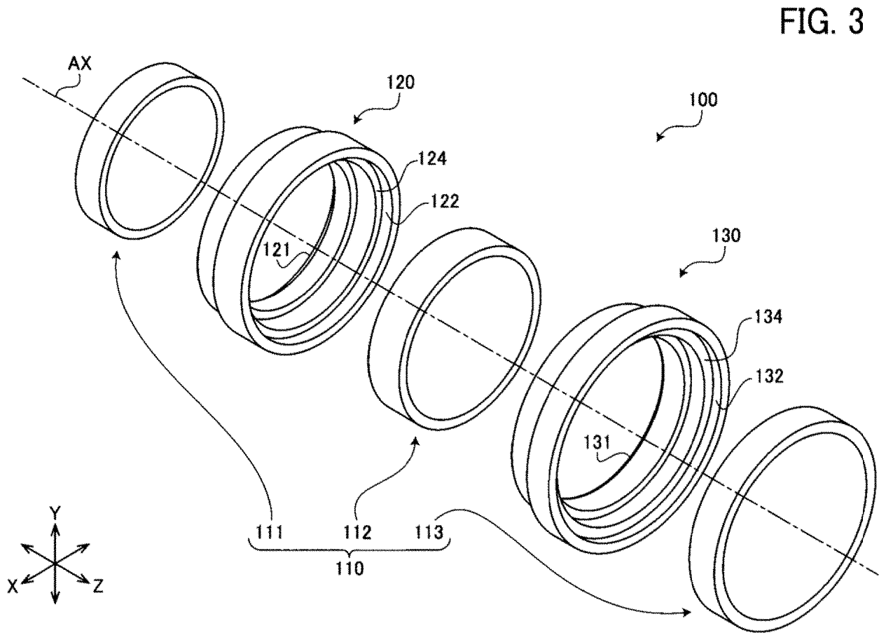

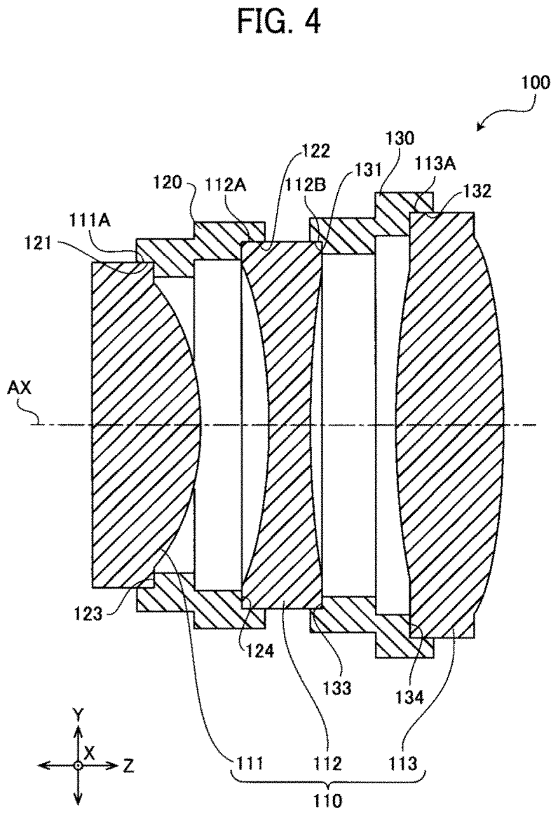

FIGS. 2 to 4 are perspective views of a configuration of a lens unit 100 according to the first embodiment. FIG. 2 is a perspective view of the lens unit 100 in the electronic apparatus in FIG. 1. FIG. 3 is an exploded perspective view of the lens unit 100 in FIG. 2. FIG. 4 is a cross-sectional view of the lens unit 100 in FIG. 2 taken along a plane including an optical axis AX.

In the following description, a direction along an optical axis AX is defined as a Z-direction, a direction orthogonal to the Z-direction is defined as an X-direction, and a direction orthogonal to both the X-direction and the Z-direction is defined as a Y-direction. For example, in FIG. 4, the X-direction is a direction orthogonal to the drawing sheet, and the Y-direction is a direction parallel to the drawing sheet.

As illustrated in FIGS. 2 to 4, the lens unit 100 according to the first embodiment includes a lens group 110 including multiple lenses arranged along the optical axis AX, a holder 120 (i.e., first holder), and a holder 130 (i.e., second holder).

The lens group 110 includes an object-side lens 111, an intermediate lens 112, and an image-side lens 113. The object-side lens 111 is disposed closest to an object side in the lens group 110. The intermediate lens 112 is disposed between the object-side lens 111 and an image-side lens 113 in the lens group 110. The image-side lens 113 is disposed closest to the image side in the lens group 110.

As viewed from the Z-direction, an outer shape of each of the lenses included in the lens group 110 (i.e., the object-side lens 111, the intermediate lens 112, and the image-side lens 113) is circular, which is, specifically, a substantially prefect circle. The outer shape is defined by an edge surface of the lens.

Each lens included in the lens group 110 is made of resin or glass (the lenses (the object-side lens 111, the intermediate lens 112, and the image-side lens 113) are resin lenses or glass lenses. In terms of weight reduction, each lens is preferably a resin lens.

Each lens included in the lens group 110 is a cemented lens obtained by cementing multiple lenses together, or a single lens.

The holder 120 is resin, and an outer shape thereof is annular. The holder 120 holds the edge surface of the object-side lens 111 and the edge surface of the intermediate lens 112. The holder 130, which is different from the holder 120, is resin and an outer shape thereof is annular. The holder 130 holds the edge surface of the intermediate lens 112 and the edge surface of the image-side lens 113.

In terms of weight reduction, each holder is preferably resin.

In the holder 120, a pressing surface 121 is formed over the entire inner peripheral surface, which is the object-side end, of the holder 120. In the holder 120, a pressing surface 122 is formed over the entire inner peripheral surface, which is the image-side end, of the holder 120. A stepped surface 123 which forms a step height (level difference) between the pressing surface 121 and a surface adjacent to the pressing surface 121 as viewed from the Y-direction is formed on the inner peripheral surface of the holder 120. A stepped surface 124 which forms a step height (level difference) between the pressing surface 122 and a surface adjacent to the pressing surface 122 as viewed from the Y-direction is formed on the inner peripheral surface of the holder 120.

In the holder 130, a pressing surface 131 is formed over the entire periphery of the object-side end of the inner peripheral surface of the holder 130. In the holder 130, a pressing surface 132 is formed over the entire periphery of the image-side end of the inner peripheral surface of the holder 130. A stepped surface 133 which makes a step between the pressing surface 131 and a surface adjacent to the pressing surface 131 as viewed from the Y-direction is formed on an inner peripheral surface of the holder 130. A stepped surface 134 which makes a step between the pressing surface 132 and a surface adjacent to the pressing surface 132 as viewed from the Y-direction is formed on an inner peripheral surface of the holder 130.

In the object-side lens 111, the image-side end 111A of the edge surface is held by the pressing surface 121 of the holder 120 over the entire periphery. Since the edge surface (i.e., image-side end 111A) is held by the pressing surface 121, the position of the object-side lens 111 in the X-direction and the Y-direction with respect to the holder 120 is determined. The peripheral portion (i.e., outside an effective range) of the image-side surface of the object-side lens 111 comes into contact with the stepped surface 123 to determine the position of the object-side lens 111 in the Z-direction with respect to the holder 120. The effective range is a range of a light flux that is effectively incident on a lens, and is typically referred to as an effective diameter when the range has a substantially perfect circular shape.

More specifically, the object-side lens 111 is held by the holder 120 by being fitted to the pressing surface 121 of the holder 120. The holder 120 is a corresponding holder to the object-side lens 111. The fit between the image-side end 111A of the edge surface of the object-side lens 111 and the pressing surface 121 of the holder 120 includes, for example, tight fit.

In order to strengthen the mechanical coupling between the object-side lens 111 and the holder 120, the object-side lens 111 and the holder 120 may be bonded together with an adhesive. The holder 120 may hold the object-side lens 111 by fitting the object-side lens 111 into the holder 120 and bonding them together.

Since the object-side lens 111 is not entirely covered by the holder 120, an adhesive is easy to apply to the object-side lens 111 and the holder 120, and the operation of bonding the object-side lens 111 and the holder 120 is facilitated.

The adhesive is, for example, an ultraviolet-curable adhesive. Since the object-side lens 111 is not entirely covered by the holder 120 in the present embodiment, irradiating the adhesive with ultraviolet rays and curing the adhesive with ultraviolet rays in the present embodiment are easier than that in a configuration in which the lens is entirely covered by a lens barrel as in the related art.

The fit between the image-side end 111A of the edge surface of the object-side lens 111 and the pressing surface 121 of the holder 120 is not limited to tight fit, and may be clearance fit or transition fit. In the case of clearance fit or transition fit, since the object-side lens 111 may move in the holder 120, the object-side lens 111 and the holder 120 are preferably bounded together with an adhesive.

Depending on specifications for the lens unit 100, the position of the object-side lens 111 in the holder 120 is adjusted and a position of the object-side lens 111 in the holder 120 may be fixed. An inner-diameter of the holder 120 (i.e., the dimension of the pressing surface 121) is set to be larger than an outer-diameter of the object-side lens 111 (i.e., the dimension of the image-side end 111A of the edge surface) so that the object-side lens 111 may move to some extent in the holder 120. As a result, the holder 120 may not hold the object-side lens 111 by fitting. In such a case, the object-side lens 111 and the holder 120 are bonded to each other with an adhesive. The holder 120 holds the object-side lens 111 by adhesion rather than by fitting the object-side lens 111 into the holder 120.

In a configuration including a lens barrel as in the related art, for example, in a case where a lens disposed on the back side of the lens barrel is adjusted, a lens to be adjusted is hard to adjust in a state where all the lenses are incorporated. Thus, the position of the lens to be adjusted is adjusted in a state in which at least some of the lenses are removed from the lens barrel (The configuration in the related art involves removing at least some of the lenses from lens barrel to adjust a lens to be adjusted.) By contrast, in the lens unit 100, the lens to be adjusted is easily adjusted even in a state in which the lenses are incorporated in the holders. As a result, the ease of assembly is improved.

Holding of the intermediate lens 112 by the holder 120 and holding of each lens by another holder are also done by fitting, bonding, or a combination thereof, similarly to holding of the object-side lens 111 by the holder 120.

In the intermediate lens 112, the object-side end 112A of the edge surface is held by the pressing surface 122 of the holder 120 over the entire periphery, and the image-side end 112B of the edge surface is held by the pressing surface 131 of the holder 130 over the entire periphery. Since the edge surface (i.e., object-side end 112A) is held by the pressing surface 122, a position of the intermediate lens 112 in the X-direction and the Y-direction with respect to the holder 120 is determined. Since the peripheral portion (i.e., outside the effective range) of the object-side surface of the intermediate lens 112 comes into contact with the stepped surface 124, a position of the intermediate lens 112 in the Z-direction with respect to the holder 120 is determined. Since the edge surface (i.e., image-side end 112B) is held by the pressing surface 131, a position of the intermediate lens 112 in the X-direction and the Y-direction with respect to the holder 130 is determined. Since the peripheral edge portion (i.e., outside the effective range) of the image side surface of the intermediate lens 112 comes into contact with the stepped surface 133, a position of the intermediate lens 112 in the Z-direction with respect to the holder 130 is determined.

In the image-side lens 113, the object-side end 113A of the edge surface is held by the pressing surface 132 of the holder 130 over the entire periphery. Since the edge surface (i.e., object-side end 113A) is held by the pressing surface 132, a position of the image-side lens 113 in the X-direction and the Y-direction with respect to the holder 130 is determined. Since the peripheral edge portion (i.e., outside the effective range) of the object side surface of the image-side lens 113 comes into contact with the stepped surface 134, a position of the image-side lens 113 in the Z-direction with respect to the holder 130 is determined.

Since the object-side lens 111 is held by the pressing surface 121 of the holder 120, and the intermediate lens 112 is held by the pressing surface 122 of the holder 120, a decentering (i.e., optical axis deviation) between the object-side lens 111 and the intermediate lens 112 is substantially prevented in the lens unit 100.

Since the intermediate lens 112 is held by the pressing surface 131 of the holder 130, and the image-side lens 113 is held by the pressing surface 132 of the holder 130, a decentering between the intermediate lens 112 and the image-side lens 113 is substantially prevented in the lens unit 100.

A holder 120 that holds the object-side lens 111 and a holder 130 that holds the image-side lens 113 are mechanically coupled and relatively fixed via an intermediate lens 112. In the lens unit 100, a decentering between the object-side lens 111 and the image-side lens 113 is also substantially prevented.

In order to further prevent the decentering among the lenses, configuration in which each holder and each lens are fitted to each other by tight fit is preferable.

A distance between the object-side lens 111 and the intermediate lens 112 along the optical axis AX is determined by holding the object-side lens 111 at position in contact with the stepped surface 123 of the holder 120 and holding the intermediate lens 112 at a position in contact with the stepped surface 124 of the holder 120. The holder 120 also works as a spacer that defines an interval between the object-side lens 111 and the intermediate lens 112 along the optical axis AX.

A distance between the intermediate lens 112 and the image-side lens 113 along the optical axis AX is determined by holding the intermediate lens 112 at a position in contact with the stepped surface 133 of the holder 130 and holding the image-side lens 113 at a position in contact with the stepped surface 134 of the holder 130. The holder 130 also works as a spacer that defines an interval between the intermediate lens 112 and the image-side lens 113 along the optical axis AX.

The lens unit 100 holds each lens by each holder disposed between the lenses. When the lens unit 100 is assembled, lenses are not inserted and arranged in a lens barrel having, for example, a longer overall length as in the related art. As a result, the ease of assemble of the lenses is improved even with more lenses. Since the ease of assembly is improved, a lead time is shortened, and the manufacturing cost is reduced.

The image-side lens 113 has a larger outer diameter than the object-side lens 111 and the intermediate lens 112. In the case of a configuration in which multiple lenses are arranged in a lens barrel as in the related art, depending on the configuration of each lens, the outer diameter of the entire lens barrel is set in accordance with the lens having the largest outer diameter. In such a configuration, the lens barrel is likely to increase in size.

By contrast, in the lens unit 100, the outer diameter of the holder 120 is not set in accordance with the image-side lens 113 having the largest outer diameter regardless of the configuration of the lenses. The outer diameter of the holder 120 may be set in accordance with the intermediate lens 112 having a smaller outer diameter than the image-side lens 113. As a result, the size and weight of the lens unit 100 is totally reduced. Since each holder does not have a size sufficient to cover the entirety of each lens, the weight of the lens unit 100 is reduced compared to a configuration including a lens barrel as in the related art.

In a conventional configuration in which multiple lenses are disposed in a lens barrel, the inner peripheral surface of the lens barrel is to be shaped to accommodate residual unevenness on the edge surface of each lens due to, for example, a gate mark and a burr generated on a parting line. In this case, the holder is designed in consideration of, for example, a molding defect due to a small thickness of the holder around such a shape.

By contrast, in the lens unit 100, when the convex portion remains in a portion of the edge surface which is not held by the holder, a shape for avoiding the convex portion on the inner peripheral surface of the holder is not formed. As a result, the design of the holder becomes easier. Even in a case where the convex portion described above remains in a portion of the edge surface held by the holder, the portion may be formed into a shape such as a notch, and thus the design of the holder is less likely to be complicated.

In the holder 120, the outer diameter of the image-side end is set in accordance with the intermediate lens 112, and the outer diameter of the object-side end is set in accordance with the object-side lens 111 having a smaller diameter than the intermediate lens 112 in order to reduce the size and weight. The holder 120 is designed such that the object-side end has a smaller diameter than the image-side end. In one or more embodiments, the holder 120 may be formed to have a constant outer diameter over the entire length to simplify the shape of the holder 120.

In the lens unit 100, a portion of the edge surface that is not held by the holder is exposed to the outside of the lens unit 100. Depending on a configuration of the optical system 10 including the lens unit 100 or the electronic apparatus 1 provided with the optical system 10, unnecessary light may enter from the exposed portion to cause ghost or flare. An edge surface of each lens may be blackening or covered with a light shielding member to prevent the occurrence of ghost and flare In addition, for example, an eaves-shape portion may be formed on the holder to prevent unnecessary light entering from the exposed portion.

### Second Embodiment

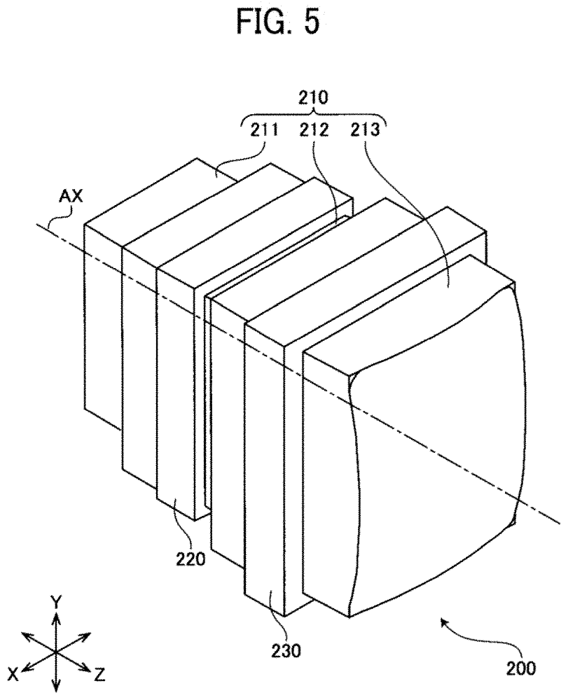

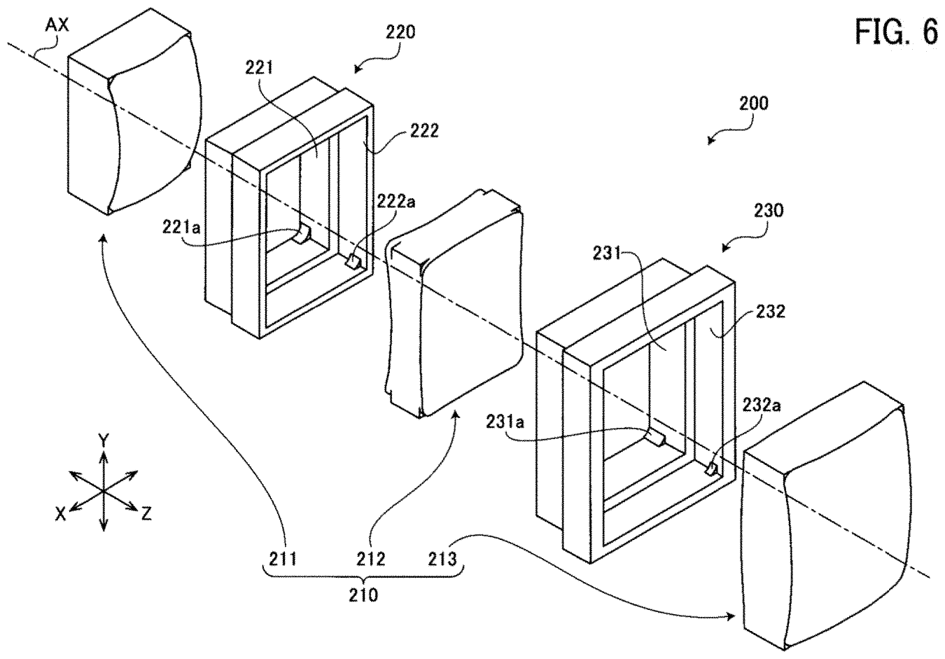

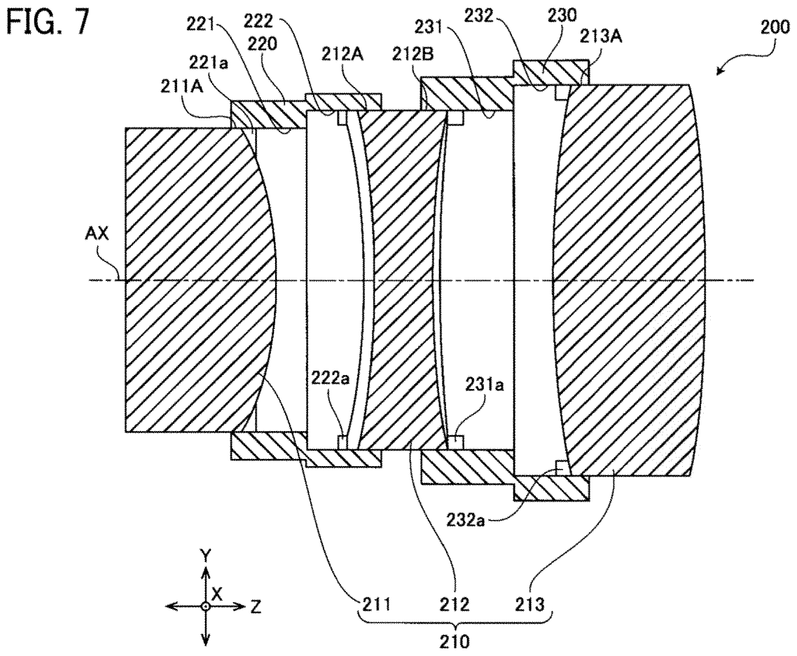

FIGS. 5 to 7 are illustrations of a configuration of a lens unit 200 according to the second embodiment of the present invention. FIG. 5 is a perspective view of the lens unit 200 incorporated in the electronic apparatus in FIG. 1. FIG. 6 is an exploded perspective view of the lens unit 200 in FIG. 5. FIG. 7 is a cross-sectional view of the lens unit 200 in FIG. 5 taken along a plane including the optical axis AX. In the embodiments below, the same reference numbers are given to the last two digits of the same configuration as the configuration described in the previous embodiments, and overlapping description will be omitted or the description will be simplified.

As illustrated in FIGS. 5 to 7, a lens unit 200 according to the second embodiment includes a lens group 210, a holder 220 (i.e., first holder), and a holder 230 (i.e., second holder). The lens unit 200 according to the second embodiment has the same configuration as the lens unit 100 according to the first embodiment except that the shapes of the lenses (i.e., the object-side lens 211, the intermediate lens 212, and the image-side lens 213) and the shapes of the holders 220 and 230 are different from the shapes of the lenses and the holders according to the first embodiment.

In the lens unit 200, each lens has a non-circular outer shape, which is, specifically, a rectangular shape, as viewed from the Z-direction. In other words, each lens has a shape with a different external dimension in each direction perpendicular to the optical axis. The non-circular outer shape is defined by a corresponding edge surface of at least one of the at least one lens. In addition, in the lens unit 200, each holder has a rectangular frame shape.

In the object-side lens 211, the entire periphery surface of the image-side end 211A of the edge surface is held by the pressing surface 221 of the holder 220. Accordingly, the position of the object-side lens 211 in the X-direction and the Y-direction with respect to the holder 220 is determined. Convex portions 221a (i.e., positioning lugs) are formed at four corners of the pressing surface 221. Since the peripheral edge portion (i.e., outside an effective range) of the image side surface of the object-side lens 211 comes into contact with each convex portion 221a, the position of the object-side lens 211 in the Z-direction with respect to the holder 220 is determined.

In the intermediate lens 212, the object-side end 212A of the edge surface is held by the pressing surface 222 of the holder 220 over the entire periphery, and the image-side end 212B of the edge surface is held by the pressing surface 231 of the holder 230 over the entire periphery. Since the edge surface (i.e., object-side end 212A) is held by the pressing surface 222, the position of the intermediate lens 212 in the X-direction and the Y-direction with respect to the holder 220 is determined. Convex portions 222a (i.e., positioning lugs) are formed at four corners of the pressing surface 222. Since the peripheral portion (i.e., outside the effective range) of the object-side surface of the intermediate lens 212 comes into contact with the convex portion 222a, the position of the intermediate lens 112 in the Z-direction with respect to the holder 220 is determined. Since the edge surface (i.e., image-side end 212B) is held by the pressing surface 231, the position of the intermediate lens 212 in the X-direction and the Y-direction with respect to the holder 230 is determined. Convex portions 231a (i.e., positioning lugs) are formed at four corners of the pressing surface 231. Since the peripheral edge portion (i.e., outside the effective range) of the image side surface of the intermediate lens 212 comes into contact with the 231a of the convex portion, the position of the intermediate lens 212 in the Z-direction with respect to the holder 230 is determined.

In the image-side lens 213, the object-side end 213A of the edge surface is held by the pressing surface 232 of the holder 230 over the entire periphery. Accordingly, a position of the image-side lens 213 in the X-direction and the Y-direction with respect to the holder 230 is determined. Convex portions 232a (i.e., positioning lugs) are formed at four corners of the pressing surface 232. Since the peripheral portion (i.e., outside the effective range) of the object-side surface of the image-side lens 213 comes into contact with the convex portion 232a (i.e., positioning lug), the position of the image-side lens 213 in the Z-direction with respect to the holder 230 is determined.

A distance between the object-side lens 211 and the intermediate lens 212 along the optical axis AX is determined by holding the object-side lens 211 at the position to contact the convex portion 221a (i.e., positioning lug) of the holder 220 and holding the intermediate lens 212 at a position to contact the convex portion 222a (i.e., positioning lug) of the holder 220. The holder 220 also works as a spacer that defines an interval between the object-side lens 211 and the intermediate lens 212 along the optical axis AX.

A distance between the intermediate lens 212 and the image-side lens 213 in the optical-axis AX direction is determined by holding the intermediate lens 212 at a position in contact with the convex portion 231a (i.e., positioning lug) of the holder 230 and holding the image-side lens 213 at a position in contact with the convex portion 232a (i.e., positioning lug) of the holder 230. The holder 230 also works as a spacer that defines an interval between the intermediate lens 212 and the image-side lens 213 along the optical axis AX.

In a case where the shape of the lens is not a substantially perfect circular shape as in the first embodiment, the lens is hard to insert into the lens barrel smoothly in a configuration in which the lens is inserted into and arranged in the lens barrel having a longer total length as in the related art, and the ease of assembly is poor. In order to improve the ease of assembly, for example, the lens and the lens barrel are fit loosely. However, if this fit is loosely set, decentering of the lenses is likely to increase.

By contrast, in the second embodiment, when the lens unit 200 is assembled, lenses in a lens barrel having a longer total length as in the related art are not inserted and arranged. Even if the fit is not loosely set, the lens can be smoothly fitted to the holder. In the second embodiment, the ease of assembly is not impaired despite the fact that the lenses are not substantially perfectly circular in shape.

### Third Embodiment

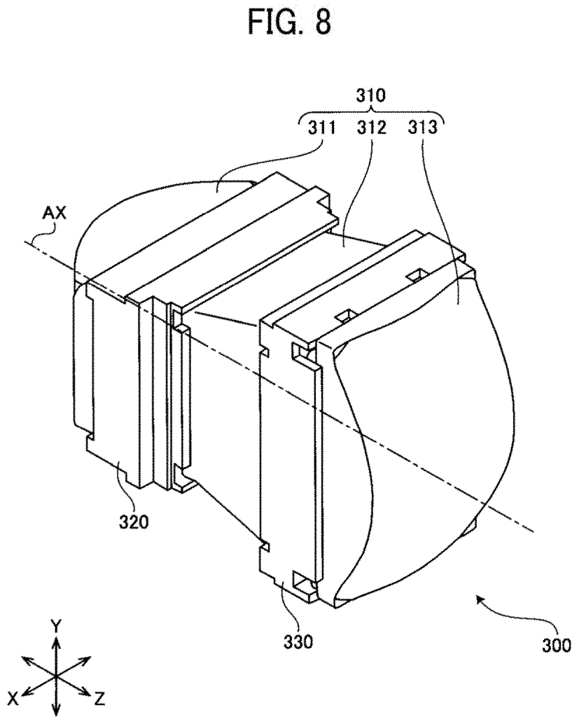

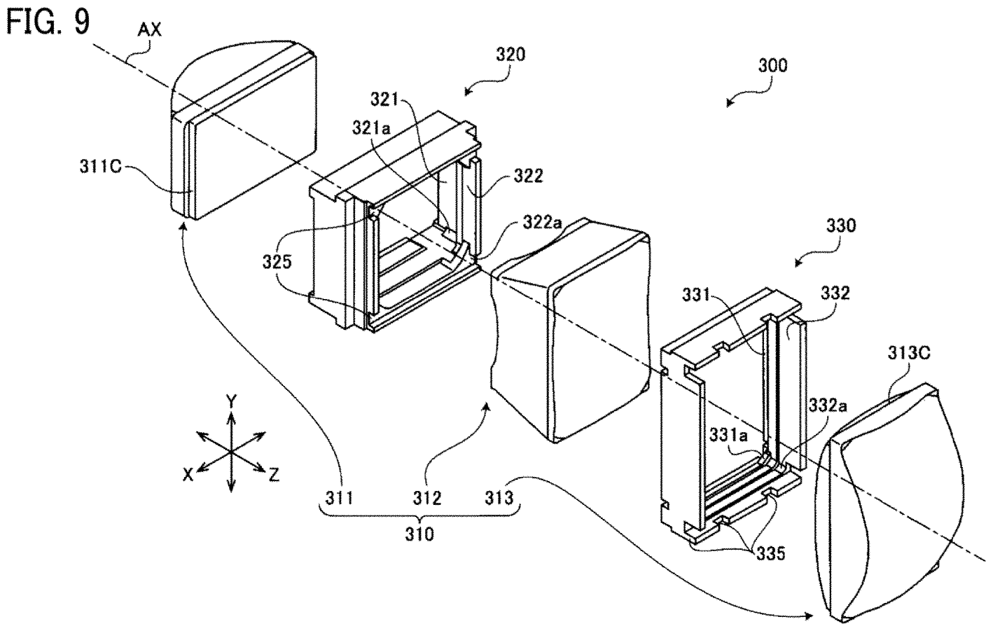

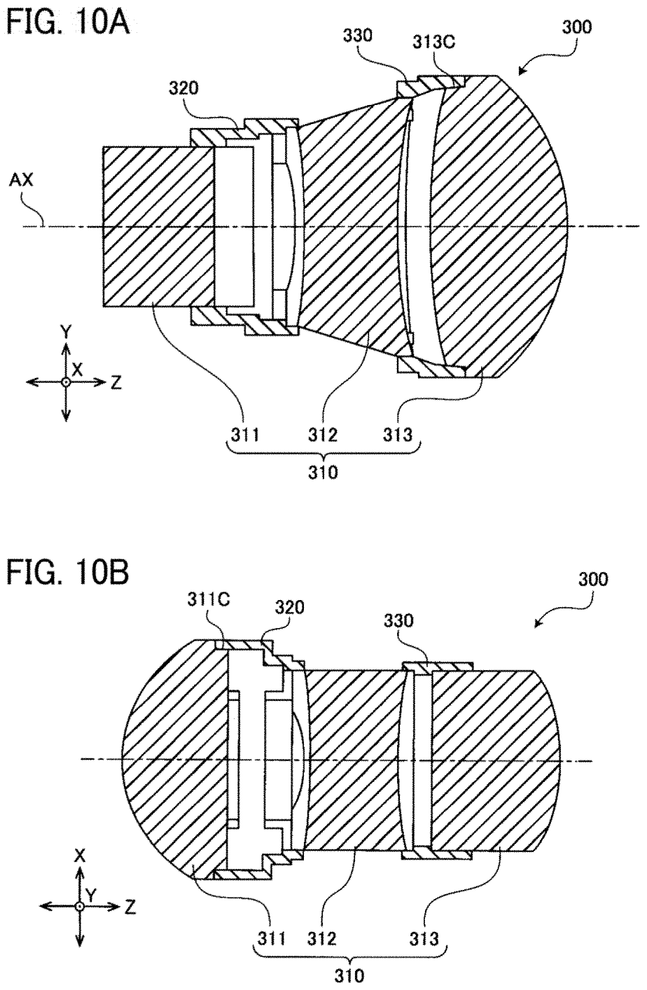

FIGS. 8 to 10 are illustrations of a configuration of a lens unit 300 according to the third embodiment of the present invention. FIG. 8 is a perspective view of the lens unit 300 in the electronic apparatus in FIG. 1. FIG. 9 is an exploded perspective view of the lens unit 300 in FIG. 8. FIG. 10A is a cross-sectional view of the lens unit 300 taken along a Y-Z plane including the optical axis AX. FIG. 10B is a cross-sectional view of the lens unit 300 taken along the X-Z plane including the optical axis AX.

As illustrated in FIGS. 8 to 10, a lens unit 300 according to the third embodiment includes a lens group 310, a holder 320 (i.e., first holder), and a holder 330 (i.e., second holder).

The lens unit 300 according to the third embodiment has the same configuration as the lens unit 100 according to the first embodiment except that the shapes of the lenses (i.e., the object-side lens 311, the intermediate lens 312, and the image-side lens 313) and the shapes of the holder 320 and 330 are different from the shapes of the lenses and the holding parts of the first embodiment.

The holder 320 is formed with a pressing surface 321 that holds the object-side lens 311, a convex portion 321a (i.e., positioning lug) that determines the position of the object-side lens 311 in the Z-direction with respect to the holder 320, a pressing surface 322 that holds the intermediate lens 312, and a convex portion 322a (i.e., positioning lug) that determines the position of the intermediate lens 312 in the Z-direction with respect to the holder 320.

The holder 320 is further formed with multiple notches 325 for facilitating injection of an adhesive for bonding each lens and each holder.

The holder 330 is formed with a pressing surface 331 for holding the intermediate lens 312, a convex portion 331a (i.e., positioning lug) that determines the position of the intermediate lens 312 in the Z direction with respect to the holder 330, a pressing surface 332 that holds the image-side lens 313, and a convex portion 332a (i.e., positioning lug) that determines the position of the image-side lens 313 in the Z-direction with respect to the holder 330.

The holder 330 is further formed with multiple notches 335 for facilitating injection of an adhesive for bonding each lens and each holder.

From a comparison between FIG. 10A and FIG. 10B, in the third embodiment, the outer dimensions of the lenses differ between the X-direction and the Y-direction. Specifically, the object-side lens 311 has a smaller outer dimension in the Y-direction than that in the X-direction. (The outer diameter of the object-side lens 311 is smaller for the Y-direction than for the X-direction) The intermediate lens 312 has a smaller external dimension in the X-direction than that in the Y-direction. The image-side lens 313 has a smaller external dimension in the X-direction than that in the Y-direction. In other words, at least one lens in the lens group 310 has a shape in which external dimensions are different in directions, and at least one lens of the object-side lens 311, the intermediate lens 312, and the image-side lens 313 each has a shape with a different external dimension in each direction.

The external dimensions of the object-side end of the holder 320 (first holder) are set in accordance with the object-side lens 311. The object-side end of the holder 320 has a smaller external dimension in the Y-direction than that in the X-direction. The external dimensions of the image-side end of the holder 320 are set in accordance with the intermediate lens 312. The image-side end of the holder 320 has a smaller external dimension in the X-direction than that in the Y-direction. The external dimensions of the object-side end of the holder 330 (second holder) are set in accordance with the intermediate lens 312. The object-side end of the holder 330 has a smaller external dimension in the X-direction than that in the Y-direction. The external dimensions of the image-side end of the holder 330 are set in accordance with the image-side lens 313. The image-side end of the holder 330 has a smaller external dimension in the X-direction than that in the Y-direction. In other words, at least one holder of the first holder and the second holder has an external dimension in each direction according to the external dimension of each of the at least one lens.

In a conventional configuration, depending on the arrangement configuration of the lenses, the diameter of the entire lens barrel is set in accordance with the largest external dimension among the external dimensions of the lenses arranged in the lens barrel. For example, when the image-side lens 313, the intermediate lens 312, and the object-side lens 311 are sequentially arranged in such a lens barre in the conventional configuration, the diameter of the entire lens barrel is set in accordance with the external dimensions of the image-side lens 313 in the Y-direction.

Unlike the conventional configuration in which the diameter of the entire lens barrel is set in accordance with the largest external dimension among those of the lenses, in the lens unit 300 according to the present embodiment, the external dimensions of the holders 320 and 330 are set in accordance with the external dimensions of the lenses in the respective directions. The lens unit is reduced in size and weight as compared with such a conventional configuration.

The object-side lens 311 has different effective ranges on the object side surface and the image side surface. Specifically, in the object-side lens 311, the effective range of the image-side surface is smaller than the effective range of the object-side surface. The edge surface of the object-side lens 311 includes a stepped portion 311C in which an image-side end portion (i.e., an end portion of the edge surface, which is closer (adjacent) to a surface having a small effective range) is recessed to be smaller than an object-side end portion (i.e., another end portion of the edge surface, which is closer (adjacent) to another surface having a large effective range). The holder 320 holds such a recess in the edge surface of the object-side lens 311, which is formed by the stepped portion 311C. The lens unit 300 is reduced in size by reducing the external dimension of the holder 320 at the portion holding the object-side lens 311 by the step height of the stepped portion 311C.

The image-side lens 313 has different effective ranges on the object side surface and the image side surface. Specifically, in the image-side lens 313, the effective range of the object-side surface is smaller than the effective range of the image-side surface. The edge surface of the image-side lens 313 has a stepped portion 313C in which an object-side end portion (i.e., an end portion on the side of a surface having a small effective range) is dropped with respect to an image-side end portion (i.e., an end portion on the side of a surface having a large effective range). At least one lens of the object-side lens, the intermediate lens, and the image-side lens includes a stepped portion to form a recess in a corresponding edge surface of the at least one lens among the edge surfaces of the object-side lens, the intermediate lens, and the image-side lens. The holder 330 holds a portion of the edge surface of the image-side lens 313 that is recessed by the stepped portion 313C. The lens unit 300 is reduced in size by reducing the external dimension of the holder 330 at the portion holding the image-side lens 313 by the step height of the stepped portion 313C.

### Fourth Embodiment

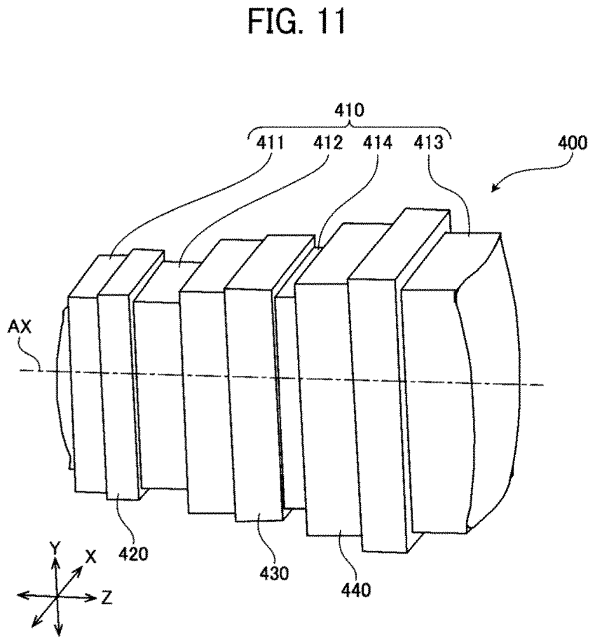

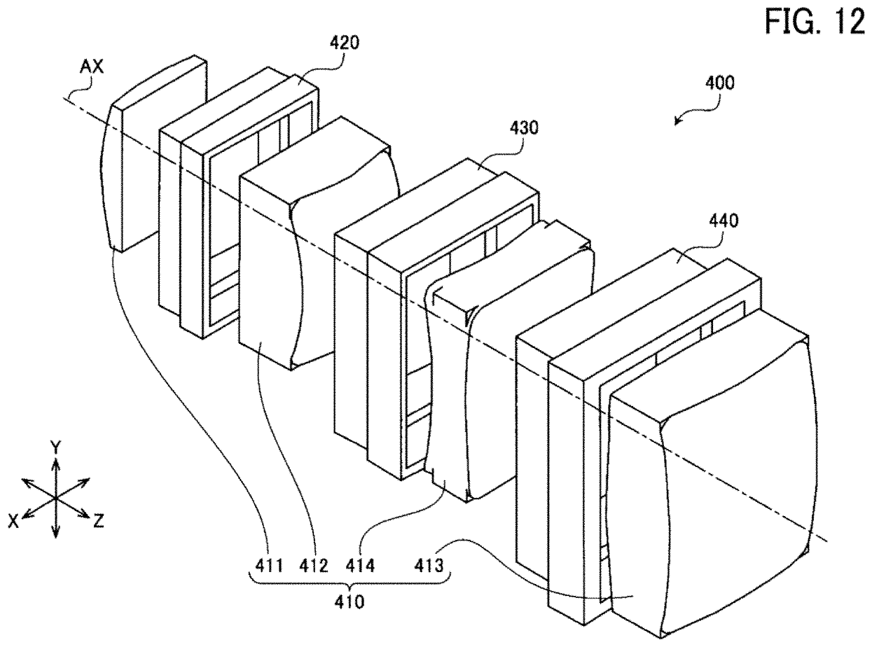

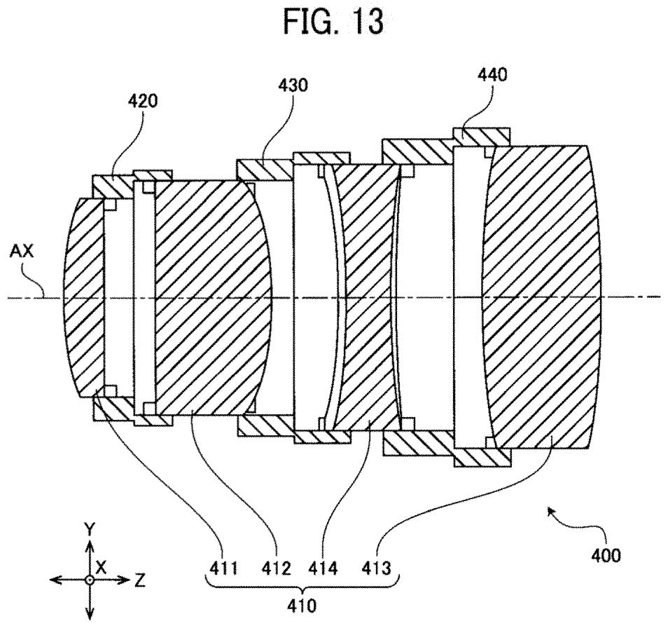

FIGS. 11 to 13 are illustration of a configuration of a lens unit 400 according to the fourth embodiment of the present invention. FIG. 11 is a perspective view of the lens unit 400 in the electronic apparatus in FIG. 1. FIG. 12 is an exploded perspective view of the lens unit 400 in FIG. 11. FIG. 13 is a cross-sectional view of the lens unit 400 in FIG. 11 taken along a plane including the optical axis AX.

As illustrated in FIGS. 11 to 13, a lens unit 400 according to the fourth embodiment includes a lens group 410, a holder 420 (i.e., first holder), a holder 430 (i.e., second holder), and a holder 440 (i.e., third holder). The lens group 410 includes multiple intermediate lenses between the object-side lens 411 and the image-side lens 413. Specifically, the lens group 410 includes the intermediate lenses 412 and 414 (i.e., two adjacent intermediate lenses).

The configuration of the lens unit 400 according to the fourth embodiment is the same as that of the lens unit 200 according to the second embodiment excluding adding one more lens and one more holder to the lens unit 200 according to the second embodiment.

Also in the fourth embodiment, for the same reason as in the embodiments described above, effects, such as improvement in the ease of assembly, reduction in size, and reduction in weight are achieved. The effects are also described in the embodiments.

The number of lenses and holders is not limited to those described in the first embodiment, the second embodiment, and the third embodiment. There is a latitude in the number of lenses and holders. A lens unit having the number of lenses and holders described in the fourth embodiment and a lens unit having more lenses and holders are also within the scope of the present invention.

### Fifth Embodiment

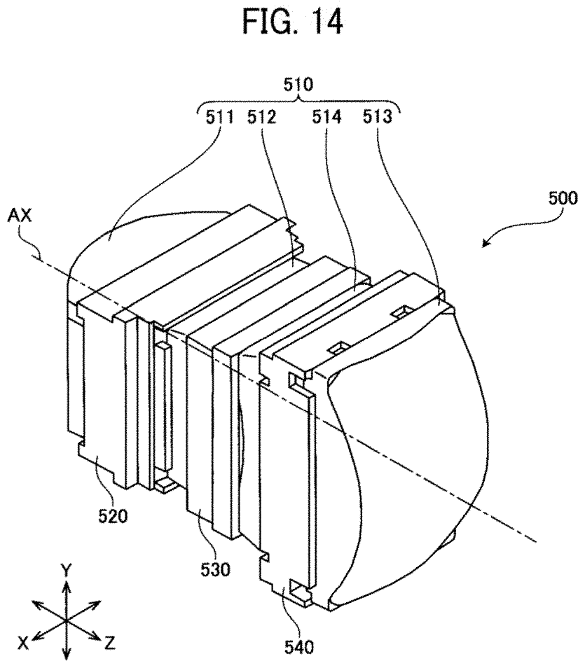

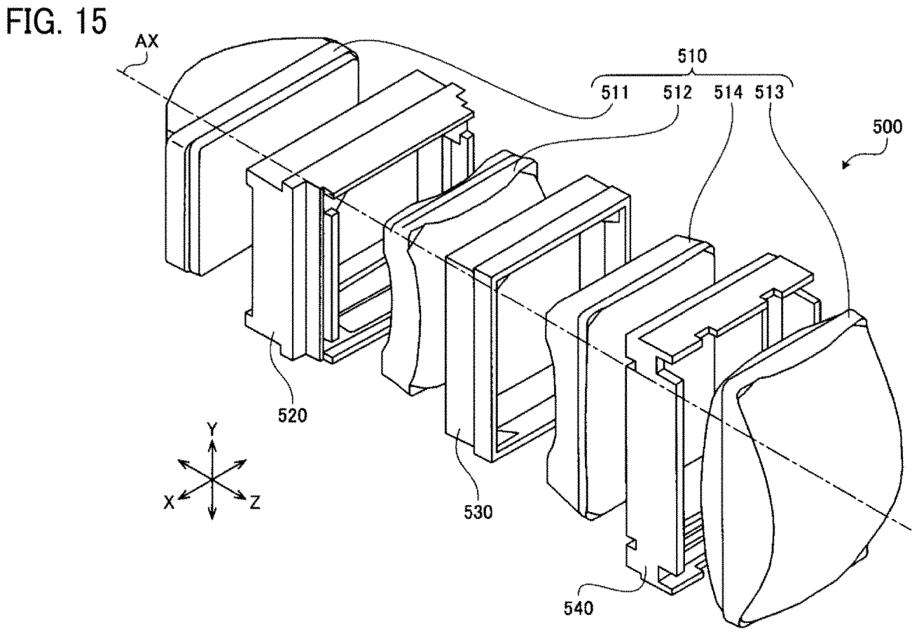

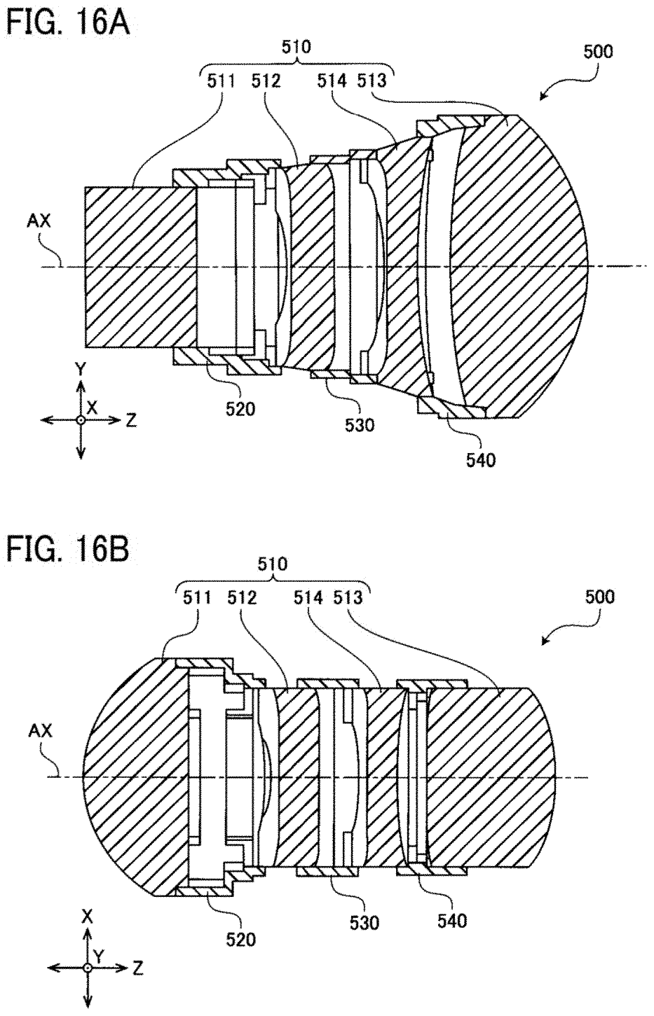

FIGS. 14 to 16 are illustrations of a configuration of a lens unit 500 according to the fifth embodiment of the present invention. FIG. 14 is a perspective view of the lens unit 500 incorporated in the electronic apparatus in FIG. 1. FIG. 15 is an exploded perspective view of the lens unit 500 in FIG. 14. FIG. 16A is a cross-sectional view of the lens unit 500 in FIG. 14 taken along the Y-Z plane including the optical axis AX. FIG. 16B is a cross-sectional view of the lens unit 500 in FIG. 14 taken along the X-Z plane including the optical axis AX.

As illustrated in FIGS. 14 to 16, a lens unit 500 according to the fifth embodiment includes a lens group 510, a holder 520 (i.e., first holder), a holder 530 (i.e., second holder), and a holder 540 (i.e., separate holder). The lens group 510 includes multiple intermediate lenses between the object-side lens 511 and the image-side lens 513. Specifically, the lens group 510 includes the intermediate lenses 512 and 514.

The lens unit 500 according to the fifth embodiment has the same configuration as that of the lens unit 300 according to the third embodiment except that one lens and one holder are added to the lens unit 300 according to the third embodiment.

Also in the fifth embodiment, for the same reason as in the embodiments described above, effects, such improvement in the ease of assembly, reduction in size, and reduction in weight are achieved. The effects are also described in the embodiments.

### Sixth Embodiment

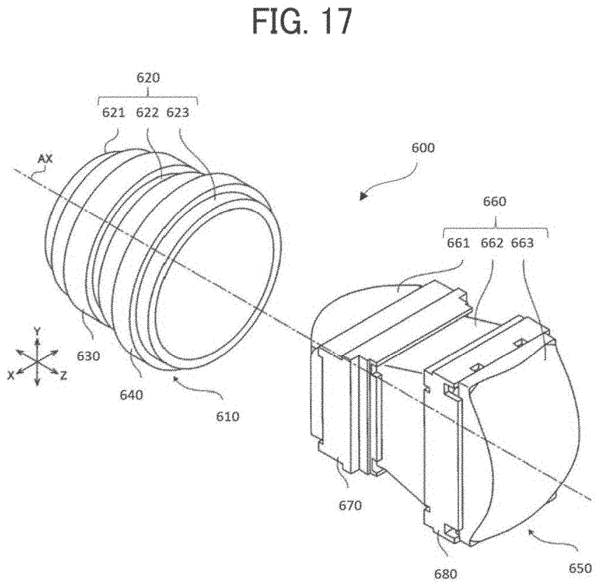

An optical system 600 according to the sixth embodiment is illustrated in FIG. 17. The optical system 600 includes a lens unit 610 (i.e., first lens unit) and a lens unit 650 (i.e., second lens unit). The lens unit 610 includes a lens group 620 (i.e., first lens group), a holder 630 (i.e., first holder), and a holder 640 (i.e., second holder). The lens group 620 includes an object-side lens 621 (i.e., first object-side lens), an image-side lens 623 (i.e., first image-side lens), and an intermediate lens (i.e., first intermediate lens) between the object-side lens 621 and the image-side lens 623. The lens unit 650 includes a lens group 660 (i.e., second lens group), a holder 670 (i.e., third holder), and a holder 680 (i.e., fourth holder). The lens group 660 includes an object-side lens 661 (i.e., second object-side lens), an image-side lens 663 (i.e., second image-side lens), and an intermediate lens 662 (i.e., second intermediate lens) between the object-side lens 661 and the image-side lens 663.

As described above, also in the lens unit having the non-circular lenses, the numbers of the lenses and the holders are not limited to those described in the first embodiment to the third embodiment. A lens unit having the number of lenses and holders described in the fifth embodiment and a lens unit having more lenses and holders are also within the scope of the present invention.

The above is a description of exemplary embodiments of the present invention. The embodiments of the present invention are not limited to those described above, and various modifications are possible within the scope of the technical idea of the present invention. For example, the embodiments of the present application also include contents obtained by appropriately combining the embodiments explicitly described in the specification or the obvious embodiments.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A lens unit comprising:
a lens group including:
an object-side lens closest to an object side in the lens group;
an image-side lens closest to an image side in the lens group; and
an intermediate lens between the object-side lens and the image-side lens,
the object-side lens, the image-side lens, and the intermediate lens being arranged along an optical axis;
a first holder holding an edge surface of the object-side lens and an edge surface of the intermediate lens; and
a second holder separate from the first holder, the second holder holding the edge surface of the intermediate lens and an edge surface of the image-side lens.

2. The lens unit according to claim 1, further comprising a third holder separate from the first holder and the second holder,
wherein the intermediate lens includes multiple intermediate lenses,
the first holder holds the edge surface of the object-side lens and an edge surface of an intermediate lens closest to an object side among the multiple intermediate lenses,
the second holder holds an edge surface of an intermediate lens closest to an image side among the multiple intermediate lenses and the edge surface of the image-side lens,
the third holder is between two adjacent intermediate lenses of the multiple intermediate lenses, and holds an edge surface of an object-side one of the two adjacent intermediate lenses and an edge surface of an image-side one of the two adjacent intermediate lenses.

3. The lens unit according to claim 1,
wherein at least one lens of the object-side lens, the intermediate lens, and the image-side lens has a non-circular outer shape defined by a corresponding edge surface of the at least one lens.

4. The lens unit according to claim 1,
wherein at least one lens of the object-side lens, the intermediate lens, and the image-side lens includes a stepped portion to form a recess in a corresponding edge surface of the at least one lens, and
wherein at least one of the first holder and the second holder holds the recess of the at least one lens.

5. The lens unit according to claim 1,
wherein at least one lens of the object-side lens, the intermediate lens, and the image-side lens is fit into a corresponding holder of the first holder and the second holder.

6. The lens unit according to claim 1,
wherein at least one of the object-side lens, the intermediate lens, and the image-side lens is bonded to a corresponding holder of the first holder and the second holder via an adhesive.

7. The lens unit according to claim 6,
wherein the adhesive is an ultraviolet-curable adhesive.

8. The lens unit according to claim 1,
wherein each of the object-side lens, the intermediate lens, and the image-side lens is made of resin.

9. The lens unit according to claim 1,
wherein each of the first holder and the second holder is made of resin.

10. The lens unit according to claim 1,
wherein at least one lens of the object-side lens, the intermediate lens, and the image-side lens has a shape with different external dimensions in directions perpendicular to the optical axis, and
a corresponding holder of the first holder and the second holder, which holds the at least one lens, has external dimensions in directions perpendicular to the optical axis according to the external dimensions of the at least one lens.

11. The lens unit according to claim 1,
wherein each of the object-side lens, the intermediate lens, and the image-side lens is a single lens or a cemented lens in which multiple lenses are cemented together.

12. An optical system comprising at least one lens unit according to claim 1.

13. An electronic apparatus comprising the optical system according to claim 12.
